(19) United States
(12) Patent Application Publication
(10) Pub. No.: US 2008/0118876 A1
(43) Pub. Date: May 22, 2008

(54) Lithographic apparatus and method

(75) Inventors: Cheng-Qun Gui, Best (NL); Rudy Jan Maria Pellens, Overpelt (BE)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/642,986

(22) Filed: Dec. 21, 2006

Related U.S. Application Data
(60) Provisional application No. 60/860,214, filed on Nov. 21, 2006.

(51) Int. Cl. G03C 5/00

(52) U.S. Cl. 430/330; 355/75; 430/269; 430/270.1

(57) ABSTRACT

In an embodiment, a ring seal forming apparatus is disclosed, the apparatus including a substrate holder arranged to hold a substrate coated at least in part with resist, and a deep ultraviolet radiation outlet configured to irradiate an area of the resist, relative movement between the substrate holder and the deep ultraviolet radiation outlet being possible, the movement being arranged such that, in use of the apparatus, the area of resist irradiated by the deep ultraviolet radiation outlet is ring-shaped.

This non-provisional application claims the benefit of and priority to U.S. Provisional Application No. 60/860,214, filed Nov. 21, 2006, the entire contents of which application is hereby incorporated by reference.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

In some circumstances it may be desirable to ensure that a certain area of resist on, for example, an outer region of the substrate is readily removable. The outer region may, for example, be a peripheral region (e.g., an edge region) of the substrate.

One such circumstance occurs, for example, when “packaging” an IC (i.e. mounting onto a board). It has been conventional to use wires to connect an IC to a board. However, in recent years the distance between locations to which wires are to be bonded has become progressively smaller, and it has been more difficult to use wire bonding. A process which is known as flip-chip bumping is increasingly used to connect an IC to a board instead of using connection wires. In flip-chip bumping, solder (or some other metal) is provided at specific locations on each IC on a substrate. The substrate is inverted and bonded to a board, for instance by heating the solder such that it melts and then allowing it to cool again.

The solder (or other metal) may itself be provided at specific locations by a lithographic process. In such a process, the substrate, which may comprise a plurality of ICs, is provided with a layer of radiation-sensitive material (resist). A lithographic apparatus may be used to irradiate the resist and the resist subsequently selectively removed at the specific locations in which a solder “bump” is required (the person skilled in the art will appreciate that these regions may be either irradiated regions or non-irradiated regions, depending upon whether a positive or negative resist is used). The IC may then undergo an electroplating step to apply the solder to the IC at the specific locations. As will be appreciated, the process of electroplating involves an electrical connection made to the article onto which metal is to be deposited. Accordingly, the electroplating step needs a resist free area of the substrate to make the electrical connection.

### SUMMARY

While it may be sufficient to provide a single resist free point for making such an electrical connection, it may be advantageous to provide a continuous ring of resist free substrate around the outer region of the substrate. Such an arrangement may enable a more reliable electrical connection. Furthermore, a continuous resist free ring around the outer edge of the substrate allows an electroplating bath to be conveniently formed using the resist free region. For example, an upstanding wall may be provided on the resist free region of the substrate, such that the substrate forms the base of the electroplating bath.

In order, for example, to ensure that good electrical connection to the substrate can be made, the resist free ring should be continuous, resist free and not contaminated. To help ensure this, it may be useful to provide that a patterned region of the substrate does not significantly encroach upon or is immediately adjacent to the resist free region (or the region which is to be subsequently made resist free). This is so that, for example, a chemical, a solution, etc. used in the processing of the patterned area of the substrate does not leak onto or into the resist free region. Such leakage may be prevented by the formation of a barrier or seal around the patterned region, which is referred to as a ring seal.

It is desirable, for example, to provide a novel apparatus and method for forming such a ring seal.

According to an aspect of the invention, there is provided a ring seal forming apparatus, comprising:

a substrate holder arranged to hold a substrate coated at least in part with resist; and

a deep ultraviolet radiation outlet configured to irradiate an area of the resist, relative movement between the substrate holder and the deep ultraviolet radiation outlet being possible, the movement being arranged such that, in use of the apparatus, the area of resist irradiated by the deep ultraviolet radiation outlet is ring-shaped.

According to a further aspect of the invention, there is provided a lithographic apparatus provided with a ring seal forming apparatus, the ring seal forming apparatus comprising:

a substrate holder arranged to hold a substrate coated at least in part with resist; and

a deep ultraviolet radiation outlet configured to irradiate an area of the resist,

wherein the substrate holder and the deep ultraviolet radiation outlet are arranged such that relative movement is possible between the substrate holder and the deep ultraviolet radiation outlet in order to irradiate a ring of resist to form the ring seal.

According to a further aspect of the invention, there is provided a substrate provided with a ring seal, the ring seal having been formed by irradiating a ring of resist on the substrate with deep ultraviolet radiation.

According to a further aspect of the invention, there is provided a method of forming a ring seal on a substrate coated at least in part with resist, the method comprising irradiating a ring of resist on the substrate with deep ultraviolet radiation.

According to a further aspect of the invention, there is provided a lithographic method comprising forming a ring seal on a substrate coated at least in part with resist by irradiating a ring of resist on the substrate with deep ultraviolet radiation.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2a to 2c depict a substrate, and a ring seal forming apparatus according to an embodiment of the present invention;

FIGS. 3a to 3c depict operating principles of embodiments of the present invention; and

FIGS. 4a and 4b are flowcharts depicting processes according to embodiments of the present invention that may be undertaken to form a ring seal.

### DETAILED DESCRIPTION

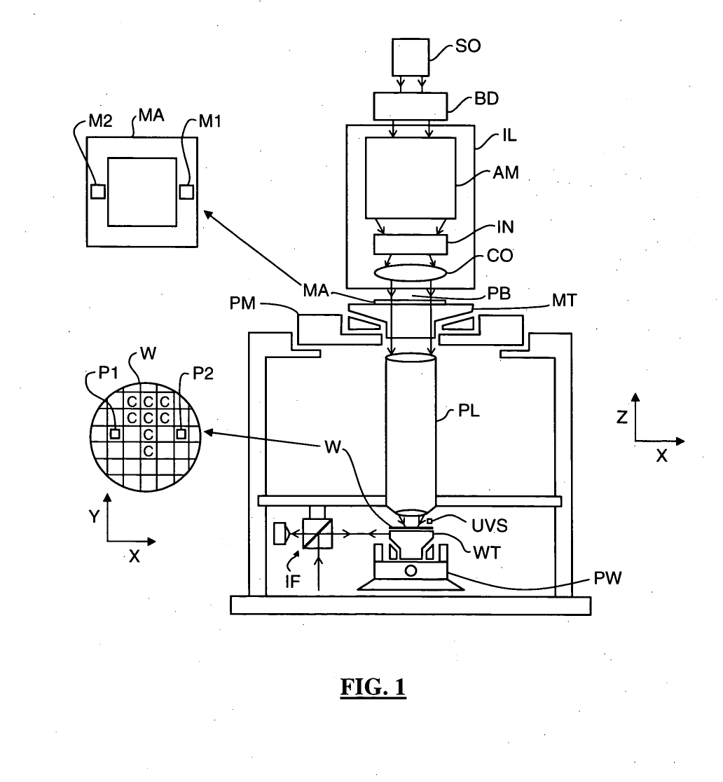

FIG. 1 schematically depicts a lithographic apparatus according to a particular embodiment of the invention. The apparatus comprises:

an illumination system (illuminator) IL to condition a beam PB of radiation (e.g. UV radiation or DUV radiation);

a support structure (e.g. a mask table) MT to support a patterning device (e.g. a mask) MA and connected to first positioning device PM to accurately position the patterning device with respect to item PL;

a substrate table (e.g. a wafer table) WT configured to hold a substrate (e.g. a resist-coated wafer) W and connected to second positioning device PW to accurately position the substrate with respect to item PL;

a projection system (e.g. a refractive projection lens) PL configured to image a pattern imparted to the radiation beam PB by patterning device MA onto a target portion C (e.g. comprising one or more dies) of the substrate W; and

an ultraviolet outlet (UVS) configured to irradiate selected parts of the resist with which the substrate W is coated, the significance of which will be described in more detail below.

As here depicted, the apparatus is of a transmissive type (e.g. employing a transmissive mask). Alternatively, the apparatus may be of a reflective type (e.g. employing a programmable mirror array of a type as referred to above).

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables and/or support structures may be used in parallel, or preparatory steps may be carried out on one or more tables and/or support structures while one or more other tables and/or support structures are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-) magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The lithographic apparatus described above may be used to form solder bumps in flip-chip bumping. The patterning device MA would be provided with a pattern which comprises the desired solder bumps. This pattern is imaged onto a thick layer of resist (i.e. thicker than a layer of resist used in conventional lithography) which is provided on the substrate W. The resist is then developed and processed such that recesses are formed at the locations where solder bumps are required. Solder is then electroplated in the recesses in the resist. The resist is then removed, so that the solder bumps project upwards from the uppermost surface of the substrate.

Accordingly, it will be appreciated that references herein to ‘substrate’ will include a substrate that already contains multiple processed layers (for example to form an IC).

As discussed above, it may sometimes be useful to prevent a patterned region from significantly encroaching upon or being immediately adjacent to the resist free region (or the region which is to be subsequently made resist free). In order to achieve this, a ring seal may be formed on the substrate W.

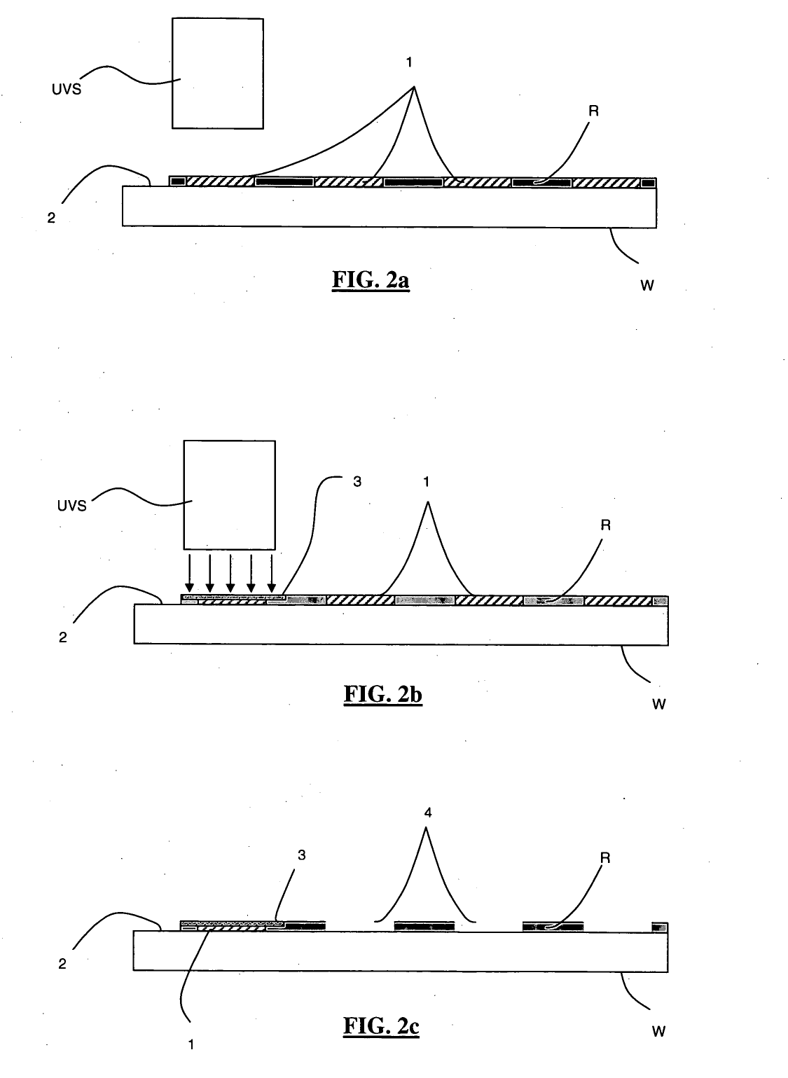

FIG. 2a illustrates the ultraviolet outlet UVS in relation to the substrate W coated with positive resist R. The ultraviolet outlet UVS is connected by, for example, an optical fiber or a mirror arrangement, to an ultraviolet source configured to emit radiation at a wavelength of 250 nm (i.e. deep ultraviolet (DUV) radiation), the source being displaced from the ultraviolet outlet UVS near the substrate. Alternatively, the ultraviolet outlet UVS may be the ultraviolet source itself. The resist R is an i-line resist, which means that it can be patterned by irradiating it with i-line radiation (e.g. 365 nm/436 nm). It can be seen from FIG. 2a that the resist R has already been patterned, for example by irradiating the resist through a patterned mask or reticle (not shown in FIG. 2a).

FIG. 2a illustrates irradiated parts of the resist 1. It can be seen that these irradiated parts 1 are separated from one another, and extend across the resist R. As is known in the art, there are three basic elements in the resist R: resin (Novolak), sensitizer (photoactive compound (PAC): Diazonaphthoquinone (DNQ)), and solvent. Upon exposure to UV radiation the DNQ molecule excites, and in the presence of water releases nitrogen gas producing a compound known as indene carboxylic acid (ICA). ICA is a polar molecule, which is therefore extremely soluble in basic aqua solutions such as metal ion free (MIF) developer and metal ion bearing (MIB) developer. The solubility of Novolak resin is dramatically enhanced by the presence of ICA. Thus, parts 1 of the resin R exposed to i-line UV radiation are, normally, readily removable using appropriate developer.

A resist free region 2 is provided on the outer edge of the substrate W, so that electrical connection to the substrate W can be easily made.

In use, the ultraviolet outlet UVS is positioned relative to the resist R on the substrate W. The ultraviolet outlet UVS may be positioned relative to an appropriate part of the resist R by moving the ultraviolet outlet UVS, or moving the substrate W, or moving both the ultraviolet outlet UVS and the substrate W.

FIG. 2b shows an outer edge of the resist R being irradiated with DUV radiation emitted from the ultraviolet outlet UVS. It can be seen that the ultraviolet outlet UVS irradiates an area of the resist 1 which has already been exposed to i-line UV radiation. The ultraviolet outlet UVS also irradiates parts of the resist R surrounding the previously irradiated area 1. Irradiation of the resist R with the DUV radiation causes a layer 3 to form. This layer 3 is a polymerized layer, formed by, amongst other processes, cross-linking. The ICA in the resist R will form an ester with the Novolak structure. The remaining PAC polymer will also form bonds with the Novolak structure (e.g. a vulcanization process will take place). The polymerized layer 3 is not soluble in MIB developer or MIF developer. Furthermore, the polymerized layer 3 is desensitized to UV radiation.

The radiation of areas of the resist R by the ultraviolet outlet UVS may be preceded and/or followed by a post exposure bake. A post exposure bake undertaken after the irradiation of appropriate areas of the resist R by the ultraviolet outlet UVS enhances the cross-linking of the polymerized layer 3, and also enhances the thermal stability of the resist R.

FIG. 2c shows the resist R when it has been developed. It can be seen that the development process has removed the majority of the areas 1 which were irradiated with i-line UV radiation. Due to the development of the resist R, it can be seen that the irradiated areas of resist 1 shown in FIGS. 2a and 2b are no longer present, and are instead replaced by gaps or indentations 4 in the resist R. Although the majority of the i-line UV irradiated areas of resist 1 have been removed by the development process, it can be seen that one area of i-line irradiated resist 1 remains. The area of i-line irradiated resist 1 which remains is located beneath the polymerized layer 3. Since the polymerized layer 3 is insoluble in developer, it has prevented the region exposed to i-line radiation 1 from being developed. Therefore, by exposing the outer region of the resist R to DUV radiation using the ultraviolet outlet UVS, a non-patterned region is formed between the resist free region 2 and the patterned regions 4 of the resist R. The polymerized layer 3 thus ensures that patterned regions of the substrate W do not significantly encroach upon or are immediately adjacent to the resist free region 2. This means that, for example, a chemical, a solution, etc. used in the processing of the patterned area of the substrate W does not leak into or onto the resist free region 2. The polymerized layer 3 therefore forms a seal.

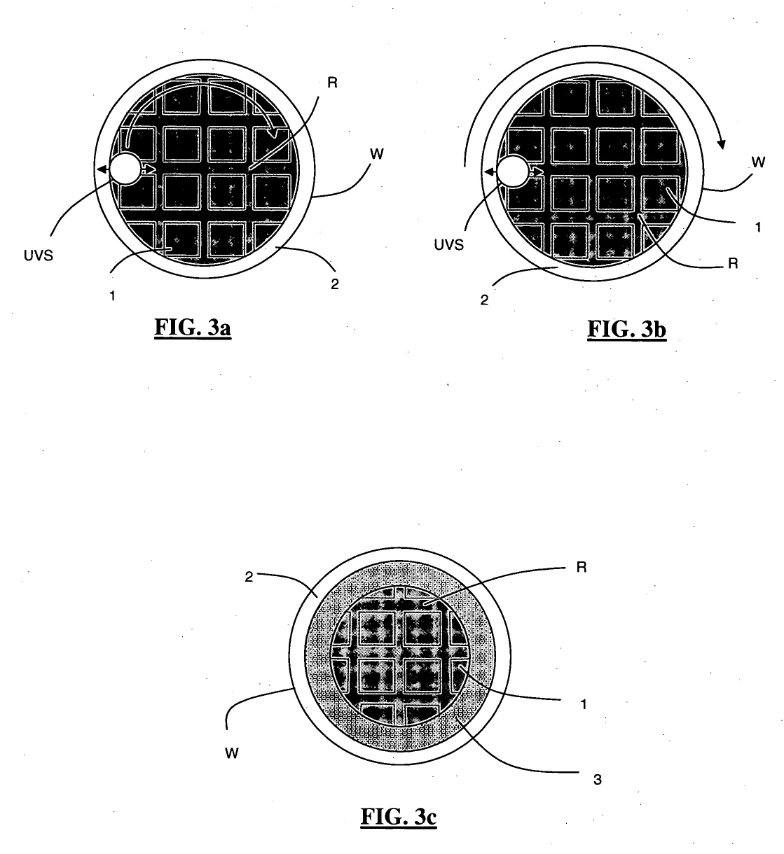

As mentioned previously, it is desirable to ensure that a seal extends around the periphery of the substrate W, i.e. that the seal is ring-shaped. FIGS. 3a to 3c illustrate how such a ring seal may be formed.

FIG. 3a is a plan view of the substrate W coated with resist R. The resist free region 2 can be seen extending around the periphery of the substrate W. Parts of the resist 1 have been exposed to i-line UV radiation, as described above. In FIG. 3a, it can be seen that the ultraviolet outlet UVS may move radially with respect of the center of the substrate W. The ultraviolet outlet UVS may also or alternatively be moved around the center of the substrate W (i.e. in a ring). Since the ultraviolet outlet UVS may move in this way, an arc or ring of resist R may be irradiated with DUV radiation. The thickness of this arc or ring may be controlled by appropriate radial movement of the ultraviolet outlet UVS. In FIG. 3b, radial movement of the ultraviolet outlet UVS is again possible, but the ultraviolet outlet UVS is not moveable around the center of the substrate W (although it may be in an embodiment). Instead, the substrate is itself rotatable to bring different areas of resist R between the ultraviolet outlet UVS and the substrate W. The substrate W may be rotated by the substrate table or holder which holds it in position (not shown in FIGS. 2 or 3). FIG. 3c shows that after exposure using the processes of FIGS. 3a or 3B, a polymerized ring-shaped layer 3 is formed. As described above, it can be seen that this ring-shaped polymerized layer 3 is not patterned. Furthermore, it is insoluble in developer and desensitized to UV radiation. The polymerized ring-shaped layer 3 is a ring seal.

The polymerized layer 3 formed by the apparatuses and methods described above may be any desired thickness, so long as it is thick enough to prevent the resist underneath the polymerized layer 3 from being developed. A typical layer of resist R may be 5 μm to 200 μm thick. In comparison, the polymerized layer 3 may be, for example 200 nm to 2 μm thick. The thicker the polymerized layer 3, the stronger it is. A thicker polymerized layer 3 is also more robust to developer, for example. However, the thicker the polymerized layer 3, the more difficult it is to remove it (which may be necessary in later processing steps). The polymerized layer 3 may be so thick that it is not possible, or is at least very difficult, to remove it using a chemical. It may well be that the polymerized layer 3 can only be removed using a plasma. A thinner polymerized layer 3 may be easily removed using an appropriate chemical. However, a thin polymerized layer 3 is not as strong as a thicker layer, and will also be more susceptible to being dissolved in developer.

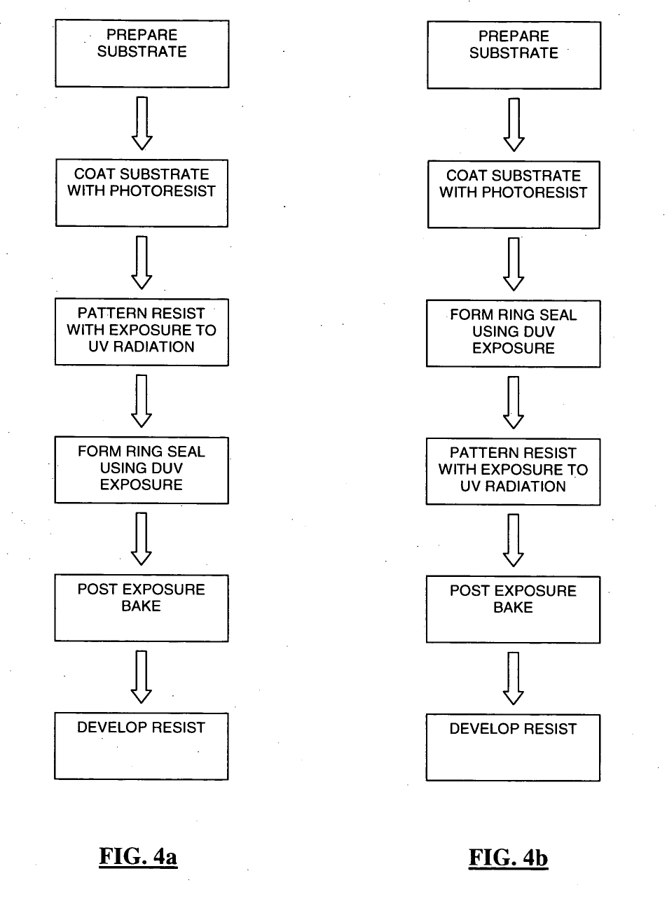

One example of a process of forming a ring seal is depicted in FIG. 4a. It can be seen that the substrate is first prepared, for example cleaned. Next, the substrate is coated with g-line, h-line, i-line or broadband photo resist. The resist is then patterned by exposing the resist to g-line, h-line, i-line or broadband ultraviolet radiation. A ring seal is then formed on the substrate by exposing a ring of resist to DUV radiation to form a polymerized layer. A post exposure bake is then undertaken to enhance the cross-linking of the polymerized layer, and also to enhance the thermal stability of the resist. The resist is then developed. However, because the polymerized layer is desensitized to UV radiation, the exposure process can be reversed. For example, in principle, appropriate areas of the resist R could be exposed to DUV radiation to form, for example, the ring seal, before the rest of the resist R is exposed to i-line radiation to form desired patterns in the resist R. Since the polymerized layer 3 is desensitized to UV radiation, it will not be patterned by the i-line radiation, and therefore the ring seal will not be compromised.

An alternative process of forming a ring seal is depicted in FIG. 4b. It can be seen that the substrate is first prepared, for example cleaned. Next, the substrate is coated with g-line, h-line, i-line or broadband photo resist. A ring seal is formed on the substrate by exposing a ring of resist to DUV radiation to form a polymerized layer. The resist (not forming the ring seal) is then patterned by exposing the resist to g-line, h-line, i-line or broadband ultraviolet radiation. A post exposure bake is then undertaken to enhance the cross-linking of the polymerized layer, and also to enhance the thermal stability of the resist. The resist is then developed.

A lower dose of DUV radiation is required to form the polymerized layer 3 if the resist R is exposed to DUV radiation before it is patterned with, for example, i-line radiation. Since a lower dose is needed, the formation of the polymerized layer 3 may be undertaken more quickly, or using a less intense ultraviolet source UVS. However, since exposure to DUV radiation will generate heat, which may slightly distort the substrate W and resist R, it may be desirable to expose the resist R to DUV radiation after it has been patterned using, for example, i-line radiation. This is to reduce the chances of applying a distorted pattern to the resist R.

A lens and/or mirror system may be provided to control the radiation emitted from the ultraviolet outlet UVS. For example, the lens and/or mirror system may control the width or cross-sectional shape of a beam of radiation emitted from the ultraviolet outlet UVS. The lens/mirror system may be used to create a beam of radiation having a diameter of between 0.5 mm and 3 mm. The width of the ring seal (i.e. the polymerized layer 3) may be defined using the lens and/or mirror system, instead of or in addition to moving the ultraviolet outlet UVS in the radial direction with respect to the center of the substrate. Alternatively, the width of the seal ring may be defined in another way, for example by moving the ultraviolet outlet UVS closer to or further away from the resist R, or by masking off selected parts of the radiation emitted from the ultraviolet source UVS.

As described above, a post-exposure bake may be undertaken to improve the cross-linking of the polymerized layer 3. Instead of or in addition to the post exposure bake, areas of the resist R exposed to DUV radiation may also be subjected to heating. The heating may be undertaken before DUV exposure, during DUV exposure, or after DUV exposure. Direct heating of the areas which are to form the ring seal, for example, may improve the cross-linking properties of the cross-linked (polymerized) layer as well as increasing its thermal stability. Heating of appropriate parts of the resist R may be undertaken using any appropriate heating source. For example, a moveable heating filament may be used, or an infra-red radiation source. An infra-red radiation source may be accompanied by a simple lens or mirror system which is able to control properties of a radiation beam emitted from the source (e.g. beam width and shape). Like the ultraviolet source for ultraviolet outlet UVS, the infra-red radiation source may be located adjacent the substrate W and resist R or be located elsewhere with the radiation transmitted via, for example, an optical fiber to the outlet for the infra-red radiation outlet near the substrate W and resist R.

In some circumstances, it may be undesirable to use a heating process, since a change in temperature may have an adverse effect on equipment and material in the vicinity of the heating process. For example, heating an area of the DUV irradiated resist to speed up the cross-linking process may inadvertently cause adjacent areas of resist to cross-link and become insoluble. In another example, apparatus within and around a lithographic apparatus is extremely sensitive to temperature change. Even a small change in temperature may adversely affect the operation of the lithographic apparatus or other equipment, material, etc. In some circumstances, therefore, it may not be desirable to use a heating and irradiation process, but instead to use only an irradiation process.

The cross-linking process may be accelerated by altering the atmosphere in which the cross-linking chemical reactions take place. For example, it may well be that the introduction of nitrogen (or any other suitable gas) into the environment in which the chemical reactions take place (i.e. in the areas of irradiation) may speed up the cross-linking process. If the cross-linking process is speeded up, the ring seal may be formed more quickly. Conversely, it may be desirable to ensure that certain gases or chemicals, for example, OH (hydroxide) are not present in the atmosphere in which the cross-linking chemical reactions are taking place. For example, hydroxide may hinder the cross-linking process, or even encourage the resist to adopt a more soluble (in developer) chemical structure. Such undesirable gases and chemicals can be purged by, for example, introducing a cross-linking enhancing gas, or an inert has, into the atmosphere. A nozzle may be provided to direct desirable or purging gases to an appropriate location, for example the region of resist R being exposed. An exhaust may also be provided to exhaust any out-gassing components or undesirable gases or chemicals from the top surface of the resist R.

In the above examples, the resist R on the substrate W has been described as being patterned by irradiating it with i-line UV radiation. However, it will be appreciated that any suitable radiation may be used. For example, the radiation used may be i-line, g-line, h-line or broadband UV radiation. It will be appreciated that the radiation used to pattern the resist will depend on the nature of the resist itself.

In the above mentioned examples, DUV radiation used to irradiate the resist R and form the polymerized layer 3 has been described as 250 nm. However, it will be appreciated that UV radiation of any wavelength in the DUV range may be used. DUV radiation having a wavelength in the range of 240 nm to 300 nm may be used, or more specifically DUV radiation having a wavelength of 248 nm, 275 nm, 193 nm, etc. may be used. Functionally, all that is required is that the radiation used to form the seal is able to form a polymerized layer in the resist which is insoluble in developer, and which may be insensitive to patterning by further exposure to UV radiation. The radiation may be DUV radiation or any other suitable radiation.

In the above mentioned examples, the ultraviolet outlet UVS is shown as emitting radiation towards a particular part of the resist R. It will be appreciated that this is not necessary, and other methods of irradiating a suitable part of the resist R is possible. For example, a mask may be employed to ensure that only a certain area of the resist R is exposed to the DUV radiation. A part of the resist R which is not masked out by the mask (i.e. a part which is exposed to DUV radiation) will, in general, become cross-linked, insoluble in developer and desensitized to further exposure to UV radiation.

In FIGS. 1-3, the ultraviolet outlet UVS is described as being a separate piece of equipment incorporated in the lithographic apparatus. However, it will be appreciated that the ultraviolet outlet UVS may be independent of the lithographic apparatus. In this case, exposure of the resist R to DUV radiation may be undertaken outside of the lithographic apparatus, for example at a pre-alignment stage or location, before or after a baking process, or in another piece of apparatus such as an edge bead removal apparatus.

A single source of radiation (e.g., the radiation source SO of FIG. 1) may be able to both pattern the resist R and also (at a different time and possibly at a different wavelength), cross-link areas of the resist R so that they are insoluble in developer and desensitized to UV radiation. For example, it may be possible to change the wavelength of a radiation source SO such that, at one wavelength, the source is able to pattern the resist R, and another wavelength, it is able to cross-link parts of the resist R. This may be achieved via the use of one or more appropriate filters.

In the embodiments described above, a polymerized ring shaped layer 3 is shown as being formed using the irradiation processes. However, it will be appreciated that any appropriate pattern can be formed, for example a semi-circle or other arc type pattern or a rectangular, elliptical, etc. ring or shape.

The apparatus and method described have been discussed in relation to flip-chip bumping. However, it will be appreciated that the apparatus and method may be used for any desired purpose, not necessarily flip-chip bumping. The method and apparatus are particularly suitable to an application where rings or arcs of resist need to be heated.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultraviolet (EUV) radiation (e.g. having a wavelength in the range of 5-20 nm), as well as particle beams, such as ion beams or electron beams.

While specific embodiments of the invention have been described above, it will be appreciated that the invention may be practiced otherwise than as described. The description is not intended to limit the invention.

1. A ring seal forming apparatus, comprising:
a substrate holder arranged to hold a substrate coated at least in part with resist; and
a deep ultraviolet radiation outlet configured to irradiate an area of the resist, relative movement between the substrate holder and the deep ultraviolet radiation outlet being possible, the movement being arranged such that, in use of the apparatus, the area of resist irradiated by the deep ultraviolet radiation outlet is ring-shaped.

2. The apparatus of claim 1, wherein the substrate holder is moveable relative to the deep ultraviolet radiation outlet.

3. The apparatus of claim 2, wherein the substrate holder is rotatable.

4. The apparatus of claim 1, wherein the deep ultraviolet radiation outlet is moveable relative to the substrate holder.

5. The apparatus of claim 4, wherein the deep ultraviolet radiation outlet is moveable in a ring.

6. The apparatus of claim 4, wherein the deep ultraviolet radiation outlet is moveable in a radial direction relative to the substrate holder.

7. The apparatus of claim 1, further comprising a lens or mirror system to control radiation emitted from the deep ultraviolet radiation outlet.

8. The apparatus of claim 1, further comprising a heat source.

9. The apparatus of claim 1, further comprising a deep ultraviolet radiation source configured to emit radiation having a wavelength selected from the group comprising: less than 193 nm, 193 nm, 248 nm, 250 nm and 275 nm.

10. The apparatus of claim 1, further comprising a deep ultraviolet radiation source configured to emit radiation having a wavelength which is sufficient to cause cross-linking or polymerization to take place in resist.

11. A lithographic apparatus provided with a ring seal forming apparatus, the ring seal forming apparatus comprising:
a substrate holder arranged to hold a substrate coated at least in part with resist; and
a deep ultraviolet radiation outlet configured to irradiate an area of the resist,
wherein the substrate holder and the deep ultraviolet radiation outlet are arranged such that relative movement is possible between the substrate holder and the deep ultraviolet radiation outlet in order to irradiate a ring of resist to form the ring seal.

12. A substrate provided with a ring seal, the ring seal having been formed by irradiating a ring of resist on the substrate with deep ultraviolet radiation.

13. A method of forming a ring seal on a substrate coated at least in part with resist, the method comprising irradiating a ring of resist on the substrate with deep ultraviolet radiation.

14. The method of claim 13, wherein the ring of resist is irradiated to remove a pattern from the ring of resist, or to prevent the irradiated ring of resist from being patterned.

15. The method of claim 13, wherein the wavelength of the deep ultraviolet radiation is less than or equal to 193 nm, 248 nm, 250 nm or 275 nm.

16. The method of claim 13, wherein the wavelength of the deep ultraviolet radiation is sufficient to cause cross-linking or polymerization to take place in the ring of resist.

17. The method of claim 13, comprising irradiating the resist to form a cross-linked or polymerized layer, the cross-linked or polymerized layer being thick enough to prevent development of resist under the cross-linked or polymerized layer when the resist is subsequently developed.

18. The method of claim 17, wherein the cross-linked or polymerized layer is at least 200 nm thick.

19. The method of claim 13, comprising rotating the substrate relative to a deep ultraviolet radiation outlet to irradiate the ring of resist with deep ultraviolet radiation.

20. The method of claim 13, comprising moving a deep ultraviolet radiation outlet around the substrate to irradiate the ring of resist with deep ultraviolet radiation.

21. The method of claim 13, wherein the resist on the substrate is exposed to radiation to apply a pattern to the resist.

22. The method of claim 21, wherein the substrate is exposed to radiation after the ring of resist has been irradiated with deep ultraviolet radiation.

23. The method of claim 21, wherein the substrate is exposed to radiation before the ring of resist has been irradiated with deep ultraviolet radiation.

24. The method of claim 21, wherein the exposure radiation is i-line, g-line, h-line or broadband ultraviolet radiation.

25. The method of claim 21, wherein the exposure radiation has a wavelength which is longer than that of deep ultraviolet radiation.

26. The method of claim 13, further comprising heating the ring of resist.

27. The method of claim 26, further comprising heating the ring of resist before, during or after irradiation of the ring of resist by deep ultraviolet radiation.

28. The method of claim 13, further comprising introducing a gas into the vicinity of the ring of resist when irradiation with deep ultraviolet radiation is taking place.

29. The method of claim 28, wherein the gas is nitrogen.

30. The method of claim 13, further comprising baking the resist coated substrate.

31. The method of claim 30, further comprising baking the resist coated substrate after the resist has been exposed to radiation.

32. A lithographic method comprising forming a ring seal on a substrate coated at least in part with resist by irradiating a ring of resist on the substrate with deep ultraviolet radiation.
